(19) United States
(12) Patent Application Publication
(10) Pub. No.: US 2025/0083610 A1
(43) Pub. Date: Mar. 13, 2025

(54) FLEXIBLE REAR STORAGE COMPARTMENT

(71) Applicant: Ford Global Technologies, LLC, Dearborn, MI (US)

(72) Inventors: Nils Kuether, Cologne (DE); Carsten Schauf, Leichlingen (DE)

(73) Assignee: Ford Global Technologies, LLC, Dearborn, MI (US)

(21) Appl. No.: 18/822,674

(22) Filed: Sep. 3, 2024

(30) Foreign Application Priority Data
Sep. 12, 2023 (DE) 102023124608.9

(51) Int. Cl. B60R 7/04; B60N 2/838

(52) U.S. Cl. CPC B60R 7/043; B60N 2/838

(57) ABSTRACT

A vehicle device for cargo space of a vehicle includes a container configured to be arranged behind a rear bench seat in an installed state and having an access on the vehicle cab side. A headrest is mounted on the rear bench seat displaceably between an upper position and a lower position. The container and the headrest are arranged on a common axis that is configured to be oriented parallel to a longitudinal axis of the vehicle in the upper position of the headrest. A pivotable lid is designed to open and close the container. The opening of the container is free in the lower position of the headrest.

### CROSS-REFERENCE TO RELATED APPLICATION

This application claims foreign priority benefits under 35 U.S.C. § 119 (a)-(d) to German Application No. 102023124608.9 filed Sep. 12, 2023, which is hereby incorporated by reference in its entirety.

### FIELD OF THE DISCLOSURE

The present disclosure generally relates to a vehicle device for cargo space of a vehicle, and more particularly relates to a vehicle device having a container arranged behind a rear bench seat in the installed state having access on the vehicle cab side.

### BACKGROUND OF THE DISCLOSURE

Motor vehicles are commonly equipped with storage compartments. It may be desirable to enhance the available cargo space of a vehicle, in particular the available cargo space of a passenger car that is accessible from the vehicle cab.

### SUMMARY OF THE DISCLOSURE

According to a first aspect of the present disclosure, a vehicle device for cargo space of a vehicle includes a container configured to be arranged behind a rear bench seat in an installed state and having an access on the vehicle cab side. A headrest is mounted on the rear bench seat displaceably between an upper position and a lower position. The container and the headrest are arranged on a common axis that is configured to be oriented parallel to a longitudinal axis of the vehicle in the upper position of the headrest. A pivotable lid is designed to open and close the container. The opening of the container is free in the lower position of the headrest.

Embodiments of the first aspect of the present disclosure can include any one or a combination of the following features:
the opening of the container is blocked in at least one position of the headrest;
a pivot axis of the pivotable lid is configured to run parallel to a lateral axis of the vehicle;
the pivot axis is arranged on the upper side of the pivotable lid;
the lid is arranged on a frame of the container that is connected pivotably to the container, wherein the pivot axis of the frame runs parallel to the lateral axis of the vehicle;
the pivot axis is arranged on the upper side of the frame;
the frame in a closed state and a backrest of the rear bench seat in an upright position are arranged, in at least one portion, coaxially on a common axis that runs parallel to the longitudinal axis of the vehicle so that pivoting of the frame is blocked by the backrest;
a locking device is arranged between the pivotable lid and the frame;
the locking device comprises a bolt;
the container is delimited by side walls comprising a top side wall, a bottom side wall, a left side wall, a right side wall and a rear side wall;
the side walls of the container are rigid;
at least the left and right side walls are flexible;
the flexible left and right side walls comprise a cloth; and
the container is mounted releasably.

According to a second aspect of the present disclosure, a vehicle has a cargo space, a rear bench seat, and a device for the cargo space. The device includes a container arranged behind the rear bench seat in an installed state. The container is arranged on a common axis that is oriented parallel to a longitudinal axis of the vehicle. A pivotable lid is designed to open and close the container.

Embodiments of the second aspect of the present disclosure can include any one or a combination of the following features:
a headrest mounted on the rear bench seat displaceably between an upper position and a lower position, wherein the container and the headrest are arranged on the common axis that is oriented parallel to the longitudinal axis of the vehicle in the upper position of the headrest, and wherein opening of the container is free in the lower position of the headrest;
the opening of the container is blocked in at least one position of the headrest;
the container has access on a vehicle cab side;
a pivot axis of the pivotable lid runs parallel to a lateral axis of the vehicle, wherein the pivot axis is arranged on the upper side of the pivotable lid; and
the pivotable lid is arranged on a frame of the container that is connected pivotably to the container, wherein the pivot axis of the frame runs parallel to the lateral axis of the vehicle, wherein the pivot axis is arranged on the upper side of the frame, and wherein the frame in the closed state and a backrest of the rear bench seat in an upright position are arranged, in at least one portion, coaxially on a common axis that runs parallel to the longitudinal axis of the vehicle so that pivoting of the frame is blocked by the backrest.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a cross-sectional view of a vehicle device arranged behind a rear bench seat in the cargo space of a vehicle with a headrest in an upper position;

FIG. 1B is a front view of the vehicle device arranged behind the rear bench seat as illustrated in FIG. 1A;

FIG. 2A is a cross-sectional view of the vehicle device arranged behind the rear bench seat with the headrest in a lower position;

FIG. 2B is a front view of a vehicle device arranged behind the rear bench seat as illustrated in FIG. 2A;

FIG. 3A is a cross-sectional view of the vehicle device arranged behind the rear bench seat illustrated in a closed position and with a stored object;

FIG. 3B is a front view of the vehicle device arranged behind the rear bench seat as illustrated in FIG. 3A;

FIG. 4A is a cross-sectional view of a vehicle device having a container according to another embodiment; and

FIG. 4B is a front view of the vehicle device having the container illustrated in FIG. 4A in a folded position.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

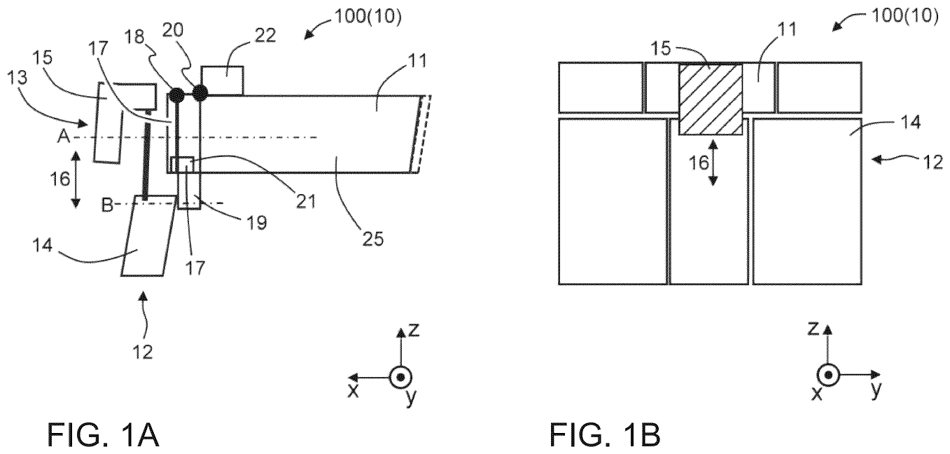

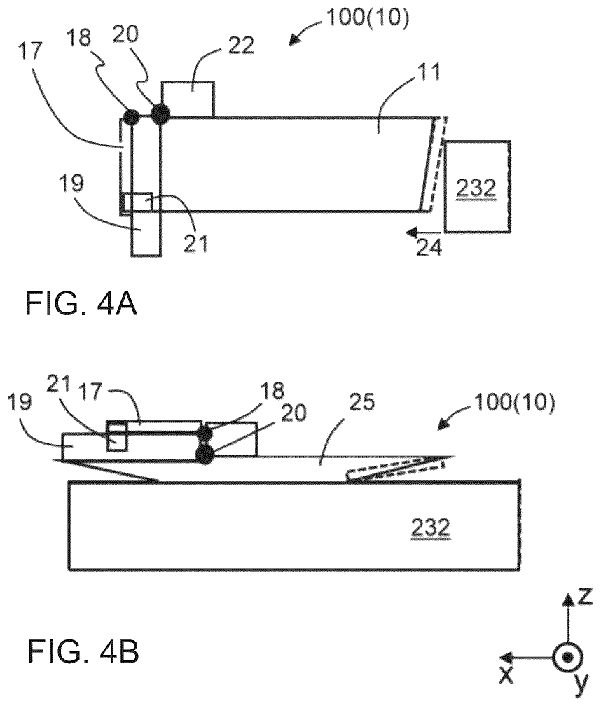

For purposes of description herein, the terms “upper,” “lower,” “right,” “left,” “rear,” “front,” “vertical,” “horizontal,” and derivatives thereof shall relate to the concepts as oriented in FIGS. 1A and 4B. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle device for enhancing the cargo space of a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The present application may refer to amounts and numbers. Unless expressly stated otherwise, such amounts and numbers should not be considered limiting but should be considered examples of the possible amounts or numbers in the context of the present application. In this context, the present application might also use the phrase “a plurality of” in order to refer to an amount or number. In this context, the phrase “a plurality of” should be in any number greater than one, e.g., two, three, four, five, etc. The terms “around”, “approximately”, “near”, etc. mean plus or minus 5% of the value specified.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

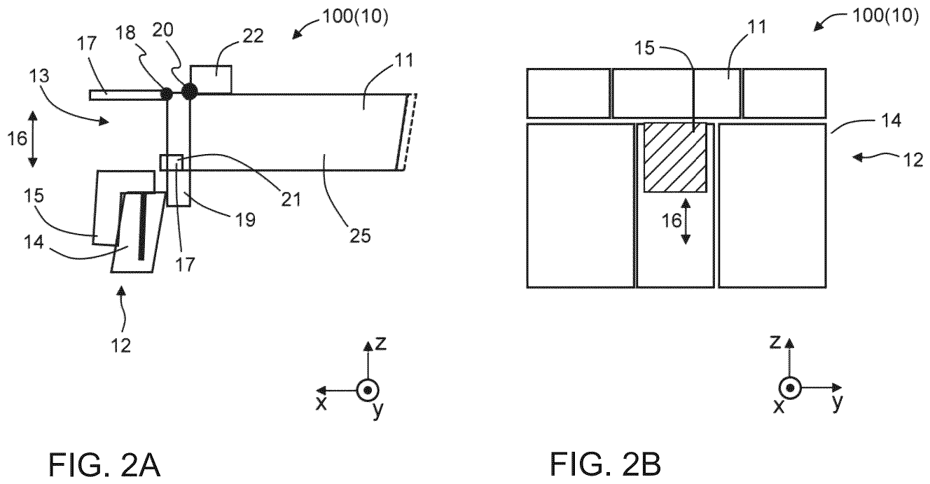

A vehicle device 100 is shown in FIGS. 1-4B and described herein. The vehicle device 100 is designed for enhancing the cargo space of a vehicle 10 (only part of which is shown), such as a motor vehicle configured with passenger seating. The vehicle device 100 has a container 11, which is arranged behind a rear bench seat 12 in the installed state and in relation to a vehicle coordinate system and has an access 13 on the vehicle cab side. The rear bench seat 12 has a backrest 14 and a headrest 15, which is mounted displaceably in the arrow direction 16 between an upper position illustrated in FIGS. 1A and 1B and a lower position illustrated in FIGS. 2A and 2B. The container 11 has a pivotable lid 17, which is designed to open and close the container 11. The pivotable lid 17 is pivotable about a horizontally arranged pivot axis 18 that runs parallel to a lateral axis of the vehicle which is the y-axis of the vehicle coordinate system. The pivotable lid 17 is hingedly mounted on a frame 19, which is likewise hingedly mounted on the container 11. The frame 19 is pivotable about a rotational axis 20, which is oriented horizontally.

A locking device 21, which can be released to open the lid 17, is arranged between the pivotable lid 17 and the frame 19. The frame 19 is dimensioned such that it lies at least in some regions on a common axis B with the backrest 14 of the rear bench seat 12, wherein the common axis B is oriented parallel to a longitudinal axis of the vehicle which is the x-axis of the vehicle coordinate system, as a result of which the frame 19 and thus the container 11 is supported on the backrest 14 of the rear bench seat 12. The container 11 is connected releasably to the vehicle 10 and in the installed state is mounted on a crossmember 22, which has suitable fastening elements (not shown).

In the first upper position of the headrest 15 illustrated in FIGS. 1A-1B, the lid 17 of the container 11 and the headrest 15 are arranged on a common axis A, which is oriented parallel to the x-axis of the vehicle coordinate system. FIGS. 1A-1B show a closed container 11. The headrest 15 is in the upper position so that it blocks opening of the lid 17 by the headrest 15.

To open the lid 17, the headrest 15 is displaced downward into the position shown in FIGS. 2A-2B, which permits the pivotable lid 17 to be pivoted upward and thus allows the container 11 to be opened. FIGS. 2A-2B show the vehicle device 100 with a headrest 15 displaced downward to a second lower position and an open pivotable lid 17 so that objects can be put into the container 11 and/or removed from the container 11.

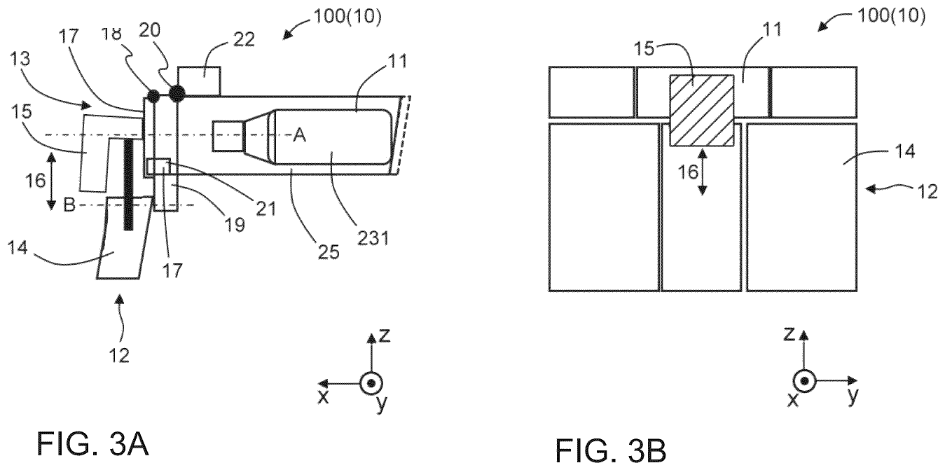

After the container 11 has been accessed, the pivotable lid 17 can be closed and the headrest 15 displaced upward in the arrow direction 16 so that it is positioned suitably and blocks opening of the pivotable lid 17. FIGS. 3A-3B show the closed position of the vehicle device 100 with an object 231 stored in the container 11.

A further embodiment of the disclosure is shown in FIGS. 4A-4B. The container shown in the figures has rigid side walls 25 at the top, bottom and rear, wherein the rear side wall 25 is hingedly connected to the top and bottom side walls 25. The right and left side walls 25 are formed from a flexible cloth so that the container 11 can be folded up in the arrow direction 24. As a result, an object 232 can be put into the luggage compartment of the vehicle 10, which folds up the container 11 as much as necessary for the object 232 to be completely stored in the luggage compartment.

According to the disclosure, it is provided for the rear bench seat to have at least one headrest that is mounted displaceably between an upper position and a lower position, wherein the container and the headrest are arranged on a common axis that is oriented parallel to the x-axis of the vehicle coordinate system, in at least one position of the headrest, and the container has a pivotable lid that is designed to open and close the container, wherein opening of the container is free in at least one position of the headrest and in particular is blocked in at least one position of the headrest.

Within the context of the present disclosure, direction statements, in particular the direction statements top, bottom, left, right, front and rear, relate to the vehicle coordinate system, which is oriented right-handedly and the x-axis of which is oriented in the direction of travel of the vehicle.

When the headrest is in the upper position intended for use, such as while the vehicle is traveling, the headrest can be positioned such that it blocks opening of the pivotable lid. In order to place objects in the container and/or to remove objects from the container, the headrest can then be displaced downward to the lower position so far that opening of the pivotable lid or of the container is not blocked. In this position of the headrest, the container can be opened by pivoting the pivotable lid, as a result of which access to the container is free on the vehicle cab side. After the container has been accessed, the pivotable lid can be closed and the headrest can be displaced back into the upper position in which it is arranged coaxially with the pivotable lid of the container and blocks opening of the pivotable lid or of the container.

However, it is also conceivable for the headrest not to block opening of the container, i.e., for opening of the container to be free, also when in a position intended for use. In this case, the headrest therefore does not have to be displaced downward first in order for opening of the container to be free.

By use of such a container, the vehicle cargo space that is accessible on the vehicle cab side is enlarged. In particular, objects that are to be reached regularly by passengers on the rear bench seat even during travel can be stowed in the container.

Advantageous developments of the disclosure are specified below.

In one embodiment, it is preferably provided for the pivot axis of the pivotable lid to run parallel to the y-axis of the vehicle coordinate system, wherein the pivot axis is preferably arranged on the upper side of the lid. The lid is preferably arranged on a frame of the container that, according to an advantageous development of the disclosure, is connected pivotably to the container, wherein the pivot axis of the frame runs parallel to the y-axis of the vehicle coordinate system. In particular, the pivot axis of the frame is arranged on the upper side of the frame. Alternatively, the pivot axes of the lid and/or of the frame can be arranged independently of one another on other sides. The lid is preferably mounted in a spring-loaded manner so that the lid can be pivoted from the open position into the closed position counter to the force of a spring. The spring provided is preferably a leaf spring or a torsion spring. Owing to the spring loading of the lid, loading with an object is made easier, because the lid does not have to be held open with one hand. Furthermore, the lid opens automatically when the lid is not locked properly, which makes the user aware of the unclosed lid.

According to an advantageous development of the disclosure, it is provided for the frame in the closed state and the backrest of the rear bench seat in the upright position to be arranged, in at least one portion, coaxially on a common axis that runs parallel to the x-axis of the vehicle coordinate system so that pivoting of the frame is blocked by the backrest.

A locking device, in particular a locking device in the form of a bolt, may be arranged between the lid and the frame so that unintentional opening of the lid is also blocked independently of the headrest position.

The container may be delimited by side walls at the top, bottom, left, right and rear. In one embodiment, the side walls of the container are rigid. According to an alternative and advantageous embodiment of the disclosure, it is provided for at least the left and right side walls to be flexible. In this case, the flexible side walls may comprise or consist of a cloth. An embodiment with flexible side walls of the container has the advantage that the container can adapt to the cargo space requirement by folding up when the luggage compartment is loaded. In this respect, even bulky objects, which also protrude into the space portion that is taken up by the container itself when the container is unfolded, can be stored in the luggage compartment.

The container is preferably mounted releasably. For this purpose, the vehicle has in particular a crossmember that has fastening elements suitable for the releasable fixing of the container.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle device for cargo space of a vehicle, the vehicle device comprising:
a container configured to be arranged behind a rear bench seat in an installed state and having an access on a vehicle cab side;
a headrest mounted on the rear bench seat displaceably between an upper position and a lower position, wherein the container and the headrest are arranged on a common axis that is configured to be oriented parallel to a longitudinal axis of the vehicle, in the upper position of the headrest; and
a pivotable lid that is designed to open and close the container, wherein opening of the container is free in the lower position of the headrest.

2. The vehicle device of claim 1, wherein the opening of the container is blocked in at least one position of the headrest.

3. The vehicle device of claim 1, wherein a pivot axis of the pivotable lid is configured to run parallel to a lateral axis of the vehicle.

4. The vehicle device of claim 3, wherein the pivot axis is arranged on the upper side of the pivotable lid.

5. The vehicle device of claim 4, wherein the lid is arranged on a frame of the container that is connected pivotably to the container, wherein the pivot axis of the frame runs parallel to the lateral axis of the vehicle.

6. The vehicle device of claim 5, wherein the pivot axis is arranged on the upper side of the frame.

7. The vehicle device of claim 6, wherein the frame in a closed state and a backrest of the rear bench seat in an upright position are arranged, in at least one portion, coaxially on a common axis that runs parallel to the longitudinal axis of the vehicle so that pivoting of the frame is blocked by the backrest.

8. The vehicle device of claim 7, wherein a locking device is arranged between the pivotable lid and the frame.

9. The vehicle device of claim 8, wherein the locking device comprises a bolt.

10. The vehicle device of claim 5, wherein the container is delimited by side walls comprising a top side wall, a bottom side wall, a left side wall, a right side wall and a rear side wall.

11. The vehicle device of claim 10, wherein the side walls of the container are rigid.

12. The vehicle device of claim 10, wherein at least the left and right side walls are flexible.

13. The vehicle device of claim 8, wherein the flexible left and right side walls comprise a cloth.

14. The vehicle device of claim 4, wherein the container is mounted releasably.

15. A vehicle comprising:
a cargo space;
a rear bench seat; and
a device for the cargo space, the device comprising:
a container arranged behind the rear bench seat in an installed state, wherein the container is arranged on a common axis that is oriented parallel to a longitudinal axis of the vehicle; and
a pivotable lid that is designed to open and close the container.

16. The vehicle of claim 15, further comprising a headrest mounted on the rear bench seat displaceably between an upper position and a lower position, wherein the container and the headrest are arranged on the common axis that is oriented parallel to the longitudinal axis of the vehicle in the upper position of the headrest, and wherein opening of the container is free in the lower position of the headrest.

17. The vehicle of claim 16, wherein the opening of the container is blocked in at least one position of the headrest.

18. The vehicle of claim 15, wherein the container has access on a vehicle cab side.

19. The vehicle of claim 15, wherein a pivot axis of the pivotable lid runs parallel to a lateral axis of the vehicle, wherein the pivot axis is arranged on the upper side of the pivotable lid.

20. The vehicle of claim 19, wherein the pivotable lid is arranged on a frame of the container that is connected pivotably to the container, wherein the pivot axis of the frame runs parallel to the lateral axis of the vehicle, wherein the pivot axis is arranged on the upper side of the frame, and wherein the frame in the closed state and a backrest of the rear bench seat in an upright position are arranged, in at least one portion, coaxially on a common axis that runs parallel to the longitudinal axis of the vehicle so that pivoting of the frame is blocked by the backrest.
